(19) United States
(12) Patent Application Publication
(10) Pub. No.: US 2009/0174366 A1
(43) Pub. Date: Jul. 9, 2009

(54) Multiple Function Switching Regulator for Use in Mobile Electronic Devices

(75) Inventors: Baher A. Ahmad, Gilbert, AZ (US); Timothy J. Herklots, Tempe, AZ (US); Jan Krellner, Chandler, AZ (US)

Correspondence Address: FSI;c/o JACKSON WALKER, LLP, 100 CONGRESS AVENUE, SUITE 1100, AUSTIN, TX, 78701, US

(73) Assignee: FREESCALE SEMICONDUCTOR, INC., Austin, TX (US)

(21) Appl. No.: 11/971,795

(22) Filed: Jan. 9, 2008

(51) Int. Cl. H02J 7/04; H02J 7/00

(52) U.S. Cl. 320/114

(57) ABSTRACT

Multiple Function Switching Regulator for Use in Mobile Electronic Devices A mobile electronic device operable to employ a rechargeable battery as a power source includes a peripheral port suitable for connecting an external device to the mobile electronic device and a power management device operable in a first mode as a battery charger to recharge the battery from an external power source and further operable in a second mode as a boost converter to power the external device from battery supplied power where the boost converter and the battery charger are provided by a single switching-converter.

### BACKGROUND

1. Field

The disclosed subject matter is in the field of power management and, more specifically, power management for mobile electronic devices.

2. Related Art

In the field of electronic devices, power management devices, frequently referred to as power management integrated circuits or PMICs are used to supply various voltages that the device may require for operation.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of selected elements of an embodiment of a mobile electronic device;

FIG. 2 is a diagram of selected elements of an embodiment of a power management integrated circuit (PMIC);

FIG. 3 is a diagram of selected elements of the PMIC of FIG. 2 emphasizing operation in a first power mode;

FIG. 4 is a diagram of selected elements of the PMIC of FIG. 2 emphasizing operation in a first power mode;

FIG. 5 is a diagram of selected elements of the PMIC of FIG. 2 emphasizing operation in a first power mode; and

FIG. 6 is a diagram of selected elements of the PMIC of FIG. 2 emphasizing operation in a first power mode.

### DETAILED DESCRIPTION

Dual role protocols refer to protocols in which compliant devices may function as a power supplier host for an attached peripheral device or as a power supply recipient. An example of a dual role protocol is Universal Serial Bus On-The-Go (USB OTG). A USB OTG compliant mobile electronic device may function as a USB power supply for an external device. The external device is attached to the mobile electronic device via a USB cable connected to a USB compliant peripheral port of the mobile electronic device.

When serving as an OTG power supply host, the mobile electronic device must provide a USB compliant power supply delivering a signal having a specified voltage (5 V) and current capacity (500 mA). Because the USB specified power supply voltage is greater than the voltage supplied by a typical rechargeable battery, the PMIC must provide a boost converter to support USB OTG. In general, however, PMIC designs are already overtaxed in terms of the number of functions required and the available space in silicon (or other semiconductor).

In one aspect, a disclosed mobile electronic device includes a PMIC to provide multiple voltage and/or current supplies for various components of the mobile electronic device. The mobile electronic device may include, for example, a processor, persistent and/or volatile storage, an LCD or other form of display, RF and/or audio components, operational LED's, and so forth. The mobile electronic device may, in addition, include a peripheral port for connecting an external device to the mobile electronic device. The mobile electronic device may comply with USB OTG or another dual role protocol under which the mobile electronic device may be operable, in a host mode, to provide a source of power source for the external device via the peripheral port. When the mobile electronic device is not connected to an AC adapter plugged into a wall socket or connected to another source of AC power, a rechargeable battery of the mobile electronic device provides the power source for the external device.

In some embodiments, the voltage level required for the external device when the mobile electronic device is in its host mode is greater than the voltage provided by the rechargeable battery. A lithium ion battery, for example, may provide a voltage of less than approximately 4.2 V whereas USB OTG requires an external supply signal of 5 V. The PMIC may include a boost regulator to generate the host mode supply voltage for the external device from the battery voltage.

The PMIC may implement the host mode boost regulator using a multiple function switching regulator. The switching regulator includes a flexible function switching module operably connected to a charge storage element such as an inductor. In host mode operation, the battery provides the input voltage to a first terminal of the inductor and the switching module controls the switching at a second terminal of the inductor to achieve a boosted DC voltage. The PMIC routes the voltage generated at the second terminal of the inductor to the peripheral port.

The switching regulator may be further operable as a battery charger via a second mode in which an external power source provides power to the mobile electronic device. In this second mode, the PMIC connects the externally supplied voltage signal to the second terminal of the inductor. The externally supplied voltage may originate from an AC adapter or from an external device connected to the peripheral port such as when the external device operates as a USB OTG host for the mobile electronic device. The switching module controls a battery switch thereby connecting the first inductor terminal and the battery to provide battery charging functionality. The battery charging may include constant current and/or constant voltage charging. The battery charging may, for example, include constant current charging initially until the battery voltage exceeds a specified voltage and then switch to constant voltage charging until the charging current drops to a specified value.

The PMIC may also supply power, via the switching regulator, to an application load of the mobile electronic device. The first terminal of the inductor, for example, may be connect to the application load. In some implementations of this embodiment, the application load may be powered by the external power source, the battery, or a combination thereof. If, for example, the mobile electronic device is being powered by an external power source and the external power source is insufficient to power the application load, the battery may temporarily suspend charging and provide supplemental power to the application load.

In another aspect, a disclosed PMIC includes a switching module operable, in conjunction with an inductor or other charge storage element, as a boost regulator that provides power to an external device from the voltage produced by a rechargeable battery. The switching module is further operable with the inductor as a switch-mode battery charger providing battery charging functionality, e.g., constant current/constant voltage charging functionality, to the battery from an externally supplied power source.

In still another aspect, a multiple function, single inductor switching regulator is operable in one mode as a boost regulator and in another mode as a switch-mode battery charger. The switching regulator includes a first switch operable to connect a rechargeable battery to a first terminal of the inductor. A switching module controls a battery switch driver to operate the first switch. A second terminal of the inductor is connected to a second switch. The switching module controls a gate driver to operate the second switch. The switching modules

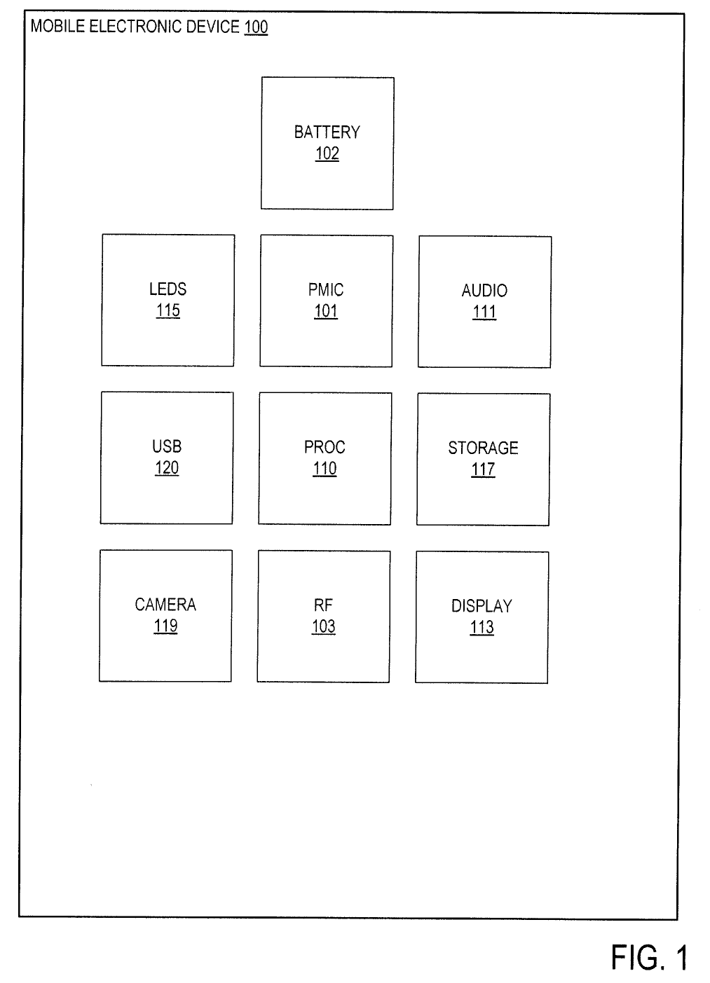

Referring now to FIG. 1, selected elements of an embodiment of a mobile electronic device are depicted. The elements of mobile electronic device 100 as presented in FIG. 1 emphasize the extensive and diverse power requirements of mobile electronic device 100 and the important role that power management plays within mobile electronic device 100. Mobile electronic device 100 encompasses a wide variety of devices including, as some of the more pervasive devices, handheld or cellular telephones, portable data assistants (PDAs), hand held computers, and the like.

In the depicted embodiment, mobile electronic device 100 includes a power management integrated circuit (PMIC) 101 that serves as a power supply for various components of mobile electronic device 100 and as a charger for a rechargeable battery 102. PMIC 101 as shown in FIG. 1 provides power for LEDs 115 and an audio module 111. Audio module 111 may include one or microphones and one or more speakers.

As depicted in FIG. 1, mobile electronic device 100 includes and PMIC 101 provides power to a processor 110 and its associated elements. In some embodiments, processor 110 may integrate a DSP/modem core for wireless communication and a digital or applications core that provides the user interface. Processor 110 may include features of commercially distributed embedded processors such as an MXC300-30 processor from Freescale Semiconductor. Processor that interfaces with a RF module 103 to provide wireless functionality for communicating with a base station as well as an applications or digital core that supports. RF module 103 may include transceivers and power amplifiers supporting various 2G+ and 3G cellular communications protocols including, as examples, GSM, EDGE, WCDMA, UMTS, and HCDPA. Other embodiments of processor 110 may employ different processors and may include distinct processors for applications and communications support.

The applications core within processor 110 has access to storage resource(s) 117, which may store computer executable instructions that provide a Linux, Symbian, or other suitable operating system. Storage resource(s) 117 may include various storage elements including, as examples, SDRAM, flash memory including embedded flash memory and a multimedia card (MMC), a subscriber identity module (SIM), and the like. Processor 110 as shown in FIG. 1 interfaces with a LCD or other type of display device 113, a CCD-based or other type of digital camera 119, a keypad (not shown), and an external or peripheral interface exemplified by UBS module 120. Mobile electronic device 100 may also include and processor 110 may support other modules or interfaces not explicitly shown in FIG. 1 including, as examples, a Bluetooth interface, a GPS interface, a WLAN or WiFi interface, and an IRDA interface.

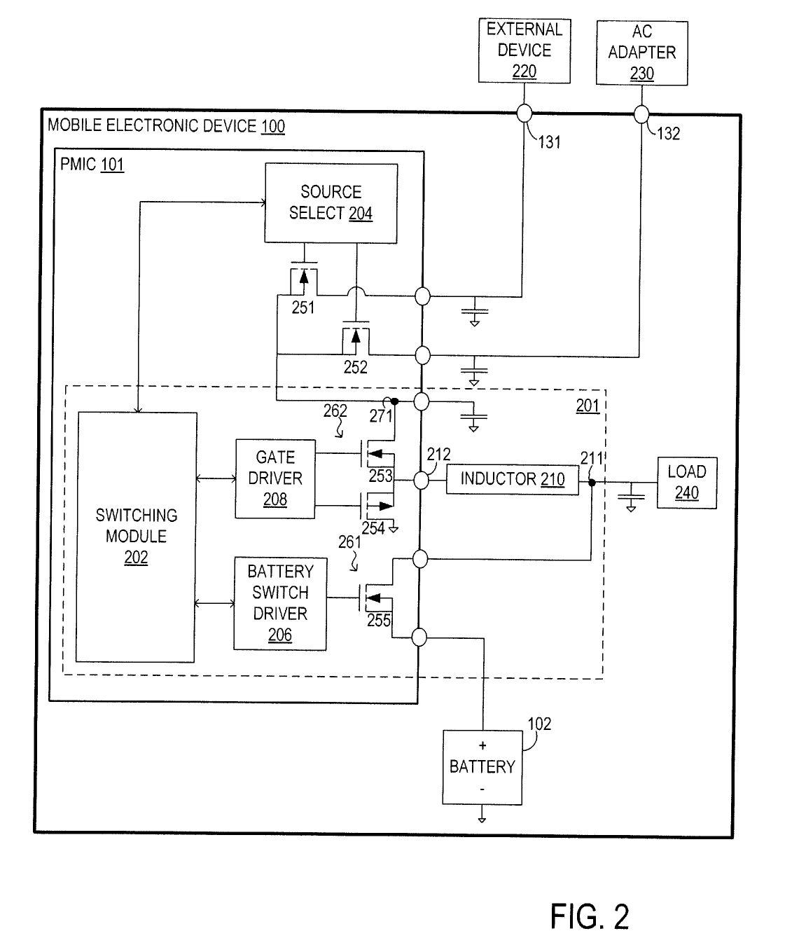

Referring now to FIG. 2, selected elements of an embodiment of PMIC 101 are depicted. The depicted embodiment of PMIC 101 illustrates a flexible switching regulator 201 suitable for providing at least two functions, namely, a boost regulator that provides power to an external device 220 when mobile electronic device 100 is operating in a host mode and a switch-mode battery charger for charging rechargeable battery 102 when mobile electronic device 100 is connected to an external source of power. By providing these dual functions in a single regulator, switching regulator 201 conserves valuable space.

Switching regulator 201 as shown in FIG. 2 includes a switching module 202 within PMIC 101 and a charge storage element represented by an inductor 210 that is external to PMIC 101. Switching module 202 controls switches that connect to inductor 210 for purposes of provider a DC to DC converter as is well known in the field of switching power supplies. As depicted in FIG. 2, switching module 202 controls a battery switch driver 206 and a gate driver 208. Battery switch driver 206 drives a first switch 261 and gate driver 208 drives a second switch 262. First switch 261 as shown in FIG. 1 is implemented as a single, NMOS transistor 255 having its source/drain terminals connected between a first terminal 211 and a positive terminal of rechargeable battery 102. Second switch 262 as shown in FIG. 1 is implemented with an NMOS transistor 254 having s/d terminals connected between ground and a second terminal 212 of inductor 210 and a PMOS transistor 255 having s/d terminals connected between second terminal 212 of inductor 210 and an upper node 271 of second switch 262. First terminal 211 of inductor 210 represents a power output terminal of switching regulator 201 that is shown as being connected to a conceptual representation (application load 240) of the applications and devices being power managed.

In the depicted embodiment, PMIC 101 further includes a source select module 204. Switching module 202 and source select module 204 may receive data and controls signals (not depicted) from external sources including, for example, from processor 110 depicted in FIG. 1. These control signals may indicate state information including, as examples, what source(s) of power are available to mobile electronic device 100, what source(s) of power drives PMIC 101, and/or what mode of operation mobile electronic device 100 is in. Source select module 204 may use this state information to control a first transistor 251 and a second transistor 252. First transistor 251 as shown is configured to connect a peripheral port 131 to upper node 271 of a second switch 262. Peripheral port 131 is suitable for connecting external device 220 to mobile electronic device 100. Peripheral port 131 may support or be compliant with an industry standard interface protocol such as the USB and/or USB OTG protocols. In these embodiments, peripheral port 131 is a USB compliant peripheral port.

Second transistor 252 as shown is configured to connect an adapter port 132 to upper node 271. Adapter port 132 provides a connector for receiving an AC adapter 230. AC adapter 230 connects to a source of AC power (not shown) such as a conventional wall outlet that provides 120 V/60 Hz. Source select module 204 generally drives either first transistor 251 or second transistor 252 depending upon whether AC adapter 230 and/or external device 220 are connected to mobile electronic device 100 and depending upon the power state of mobile electronic device 100. By controlling first transistor 251 and second transistor 252, source select module 204 may selectively couple either external device 220 or AC adapter 230 to upper node 271 of second switch 262.

Switching module 202 may include various modules including modules that will be familiar to those of ordinary skill in the field of switch-mode supplies. These modules may include, as examples, a pulse width modulation (PWM) buck-boost module, a charger control module, and appropriate reference voltages and feedback paths to enable regulated operation.

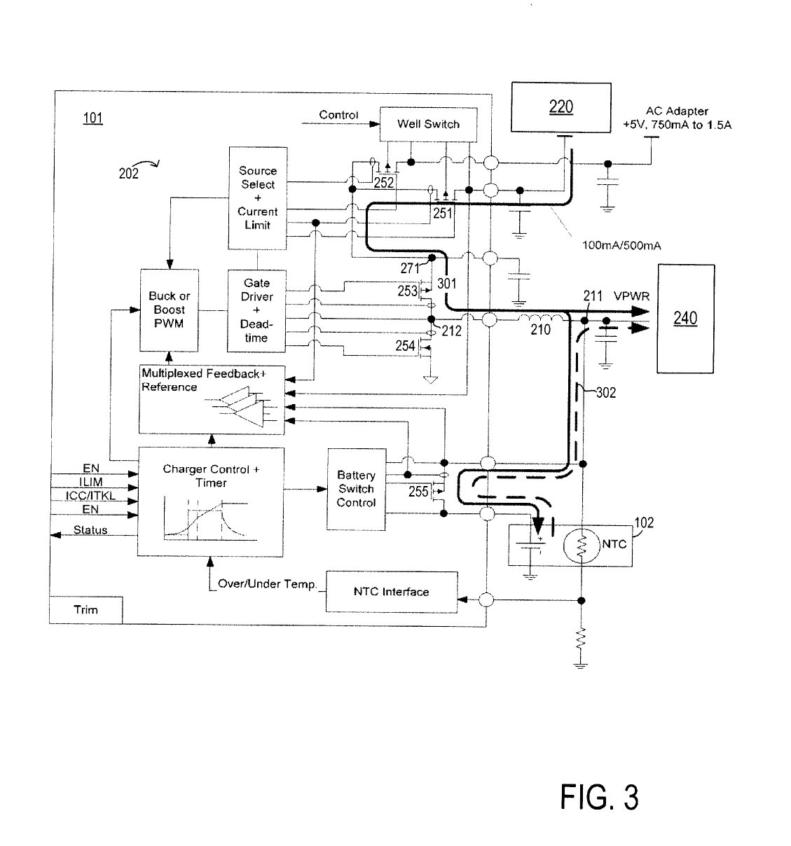

Referring now to FIG. 3 through FIG. 6, operation of PMIC 101 and switching regulator 201 are illustrated in various modes of operation. In FIG. 3, mobile electronic device 100 and PMIC 101 are powered by external device 220, which provides a USB compliant 5V signal. The solid power/current flow indicator 301 illustrates power flowing through first transistor 251 to upper node 271, through transistor 253 to second terminal 212 of inductor 210, through inductor 210 to first terminal 211 of inductor 210 and through transistor 255 to charge rechargeable battery 102. In addition, indicator 301 illustrates current/power flowing to application load 240. In this mode, external device 220 provides for application load 240 and for charging rechargeable battery 102. PMIC 101 and switching module 202 are further operable to enable reverse battery operation under which, power within rechargeable battery 102 is used to supplement the power provided to application load 240 by external device 220. When the application load power decreases, charging of rechargeable battery 102 resumes. This reverse battery power flow is represented by flow indicator 302.

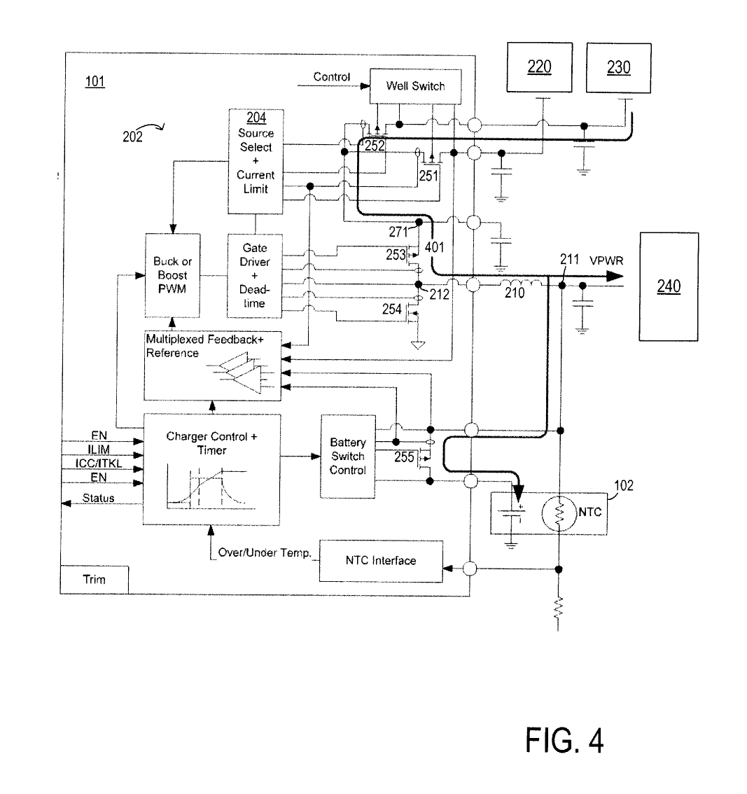

In the mode of operation depicted in FIG. 3, switching module 202 may control second switch 262 to achieve buck converter operation to step down the external voltage (typically 5V or higher) to a voltage level desirable for application load 240. Simultaneously, switching module 202 may control battery switch driver 206 to achieve battery charging functionality to charge battery 102. As indicated previously and shown in FIG. 4, switching module 202 may include a battery charging module to operate transistor 255, via battery switch driver 206, as a constant current circuit for an initial duration that terminates when a battery output voltage exceeds a specified value, at which point switching module 202 might then operate transistor 255 as a constant voltage regulator until a charging endpoint is detected, perhaps when the charging current flowing through transistor 255 drops below a specified value, which may represent the specified value as a percentage of or a percentage decrease from a maximum current.

Referring to FIG. 4, operation of mobile electronic device 100 and PMIC 101 are illustrated for an environment in which AC adapter 230 is connected to mobile electronic device 100. In this mode, source select module 204 may detect and recognize AC adapter 230 as an available and preferred source of power. Source select module 204 may then provide power to mobile electronic device 100 and PMIC 101 by activating second transistor 252 to connect AC adapter 230 to upper node 271 of second switch 262 as illustrated by power flow indicator 401. From upper node 271, the power flows through transistor 253 of second switch 262 to second terminal 212 of inductor 210, through inductor 210 to first terminal 211 of inductor 210, and from first terminal 211 of inductor 210 through transistor 255 to rechargeable battery 102. In addition, power flow indicator 401 illustrates power flowing from first terminal 211 of inductor 210 to application load 240. In this mode, AC adapter 230 provides power sufficient to power application load 240 while simultaneously charging rechargeable battery 102. While AC adapter 230 is generally presumed to provide sufficient power to satisfy both demands, reverse battery operation is still possible if the power consumed by application load 240 exceeds the power provided by AC adapter 230.

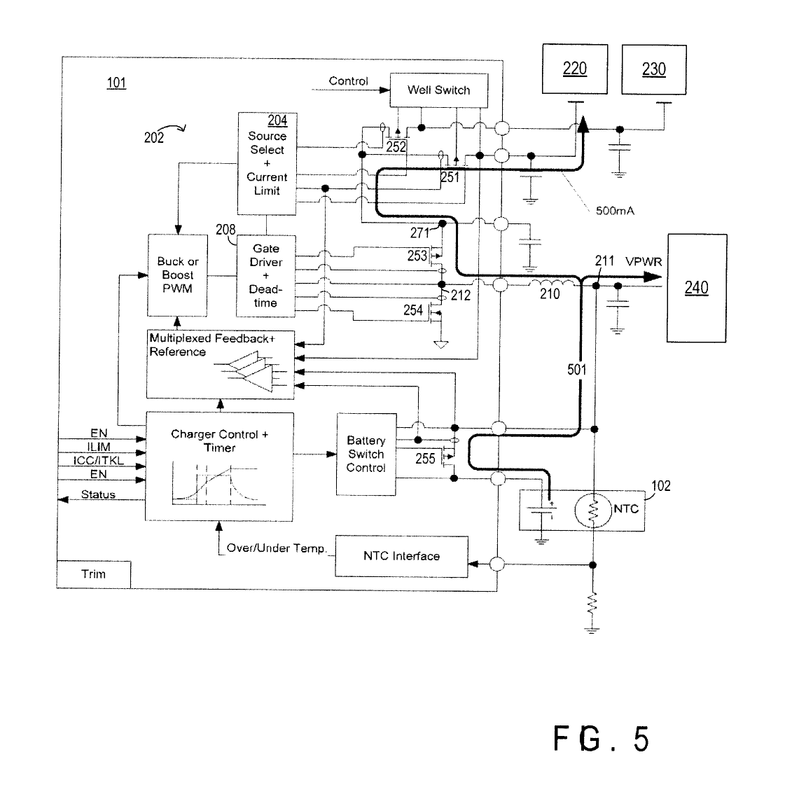

Referring to FIG. 5, operation of mobile electronic device 100 and PMIC 101 are illustrated for a USB OTG configuration in which mobile electronic device 100 is the USB power host. In this mode of operation, rechargeable battery 102 provides the power source and power/current flow indicator 501 flows from rechargeable battery 102, through transistor 255 to first terminal 211 of inductor 210, through inductor 210 to second terminal 212, through transistor 253 of second transistor 252 to first transistor 251 and through first transistor 251 to external device 120. In this mode, switching module 202 controls gate driver 208 to achieve boost converter functionality in which the voltage at second terminal 212 of inductor 210 is greater than the voltage at first terminal 211 of inductor 210. This boost functionality is needed or desirable for USB OTG applications where the voltage of rechargeable battery 102 is generally a maximum of 4.2 V, and frequently less, while the power signal provided to external device 220 needed for compliance with USB OTG is a 5V 500 mA signal.

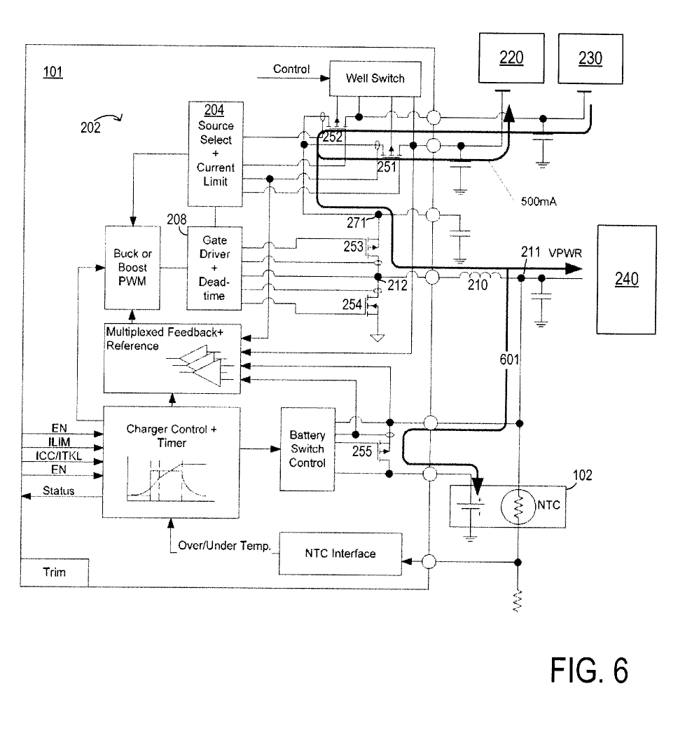

Referring to FIG. 6, operation of mobile electronic device 100 and PMIC 101 are illustrated for a mode of operation in which external device 220 and AC adapter 230 are both connected to mobile electronic device 100. In this mode, the power flow indicator 601 illustrates AC adapter 230 as the source of power. Source select module 204 may activate both first transistor 251 as well as second transistor 252 so that power flow may proceed from AC adapter 230 through second transistor 252 and first transistor 251 to provide power to external device 220. In addition, as shown, power flow indicator 601 illustrates power also flowing from AC adapter 230 through second transistor 252 to upper node 271 of second switch 262, through second switch 262 to second terminal 212 of inductor 210, through inductor 210 to first terminal 211, where the power may be provided to application load 240 while simultaneously providing additional power to rechargeable battery 102. In this mode of operation inductor 210 may provide an appropriate step down function while battery 102 is maintained in its battery charging state.

As illustrated in the diagrams above, the described embodiment of PMIC 101 enables dual functionality from a single switching regulator 201 including a step up converter and a battery charger. By doing so, PMIC 101 achieves improved functionality without substantially increasing the die size of PMIC 101.

Although the invention is described herein with reference to specific embodiments, various modifications and changes can be made without departing from the scope of the present invention as set forth in the claims below. For example, although PMIC 101 is shown as including the individual transistors 251 through 255, other embodiments of mobile electronic device 100 may implement these devices external to PMIC 101. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A mobile electronic device operable to employ a rechargeable battery as a power source, the mobile electronic device including:
a peripheral port suitable for connecting an external device to the mobile electronic device; and
a switching converter operable in a first mode as a battery charger to recharge the battery from an external power source and further operable in a second mode as a boost converter to power the external device from battery supplied power.

2. The mobile electronic device of claim 1, wherein the switching converter is operable in the first mode to recharge the battery from power provided by the external device via the port.

3. The mobile electronic device of claim 1, wherein the peripheral port comprises a universal serial bus (USB) port and wherein the switching converter provides a USB compliant power signal to the external device.

4. The mobile electronic device of claim 1, further comprising an adapter connector suitable for receiving a DC output of an AC adapter and further wherein the switching converter is operable in the first mode to recharge the battery from the DC output of the AC adapter.

5. The mobile electronic device of claim 1, wherein the switching converter includes an inductor connected to at least one switch and a switching module operable to control the switch.

6. The mobile electronic device of claim 5, further comprising a second switch wherein the inductor connected is connected to the two switches, wherein the switching module is operable to control the first switch to provide the boost converter and the switching module is operable to control the second switch to provide the battery charger.

7. The mobile electronic device of claim 6, wherein the switching converter is further operable to power an application load of the mobile electronic device.

8. The mobile electronic device of claim 7, wherein the switching converter is operable in the first mode to provide at least a portion of the application load power from the external power supply.

9. The mobile electronic device of claim 8, wherein the switching converter is operable in the first mode to provide at least a portion of the load power from the battery when the application load power exceeds the power of the external power supply.

10. The mobile electronic device of claim 7, wherein the switching converter is operable in the second mode to provide the load power and the external device power.

11. The mobile electronic device of claim 1, wherein the peripheral port is a universal serial bus (USB) port and wherein the mobile electronic device is USB on-the-go (OTG) compliant.

12. A switching DC converter suitable for use in a mobile electronic device wherein the converter is operable, in a first mode, to recharge a battery of the mobile electronic device from an external power source and further operable, in a second mode, to power an external device connected to a peripheral port of the mobile electronic device from a battery of the mobile electronic device, wherein an energy storage element employed in the first mode and an energy storage element employed in the second mode are the same energy storage element.

13. The switching converter of claim 12, wherein the converter is further operable, in the first mode, to power an application load of the mobile electronic device from the external power source while recharging the battery.

14. The switching converter of claim 13, wherein the converter is further operable, in the first mode, to perform the battery recharging and provide at least a portion of the application load power from the battery when the application load exceeds the capacity of the external power source.

15. The switching converter of claim 12, wherein the converter is further operable, in the second mode, to power an application load of the mobile electronic device while powering the external device.

16. A power management integrated circuit (PMIC) of a mobile electronic device, the PMIC operable in a first mode as a switch-mode battery charger for recharging a battery of the mobile electronic device and operable in a second mode as a boost converter for powering an external device connected to the mobile electronic device wherein the first mode and the second mode employ a common inductor.

17. The PMIC of claim 16, wherein the PMIC is operable in the second mode as a Universal Serial Bus (USB) compliant power supply.

18. The PMIC of claim 16, wherein the PMIC, in the first mode, receives an input voltage from an external device connected to the PMIC via a Universal Serial Bus and wherein the PMIC is operable, in the first mode, as a recharger selected from a constant current recharger and a constant voltage recharger.

19. The PMIC of claim 16, wherein the PMIC includes:
a source select module operable to connect an upper node of an upper switch to an adapter port for connecting to an AC adapter or a peripheral port for connecting to a peripheral device;
a gate driver for controlling the upper switch to connect the upper node to second terminal of an external inductor; and
a battery switch driver for controlling a lower switch to connect a first terminal of the external inductor to a first terminal of a battery.

20. The PMIC of claim 19, wherein the PMIC further includes a switching module operable to control the source select module, the gate driver, and the battery switch driver.
